(19) United States
(12) Patent Application Publication
(10) Pub. No.: US 2024/0321488 A1
(43) Pub. Date: Sep. 26, 2024

(54) COIL COMPONENT, CIRCUIT BOARD ARRANGEMENT AND METHOD OF MAKING COIL COMPONENT

(71) Applicant: TAIYO YUDEN CO., LTD., Tokyo (JP)

(72) Inventor: Shintaro TAKAHASHI, Tokyo (JP)

(73) Assignee: TAIYO YUDEN CO., LTD., Tokyo (JP)

(21) Appl. No.: 18/612,402

(22) Filed: Mar. 21, 2024

(30) Foreign Application Priority Data
Mar. 22, 2023 (JP) 2023-045471

(51) Int. Cl. H01F 1/03; H01F 27/02; H01F 27/29

(52) U.S. Cl. CPC H01F 1/0306; H01F 27/022; H01F 27/292

(57) ABSTRACT

A coil component includes a magnetic body, made from an insulating material and metal magnetic particles joined by the insulating material. The magnetic body has a first surface and a second surface, and the first surface is adjacent to the second surface. A surface resistivity of the second surface is higher than a surface resistivity of the first surface. The coil component also includes a conductor portion provided inside or on the magnetic body. The coil component also includes an outer electrode provided on the first surface and connected to the conductor portion.

### FIELD OF THE INVENTION

The present invention relates to a coil component, a circuit board arrangement and a method of manufacturing the coil component.

### DESCRIPTION OF THE RELATED ART

Mobile phones are known as high-performance electronic devices. Electronic components used in the mobile phones are required to have high performances and small sizes. Further, in some electronic devices, it is necessary to increase the number of electronic components on a board of the electronic device, i.e., the electronic components are mounted on the board at a high density. In order to realize high-density mounting of the electronic components, downsizing of the electronic components and narrowing of the intervals (pitches) between the electronic components are required.

In a conventional design that achieves the narrowed pitch of the electronic components, outer electrodes are often provided only on the mounting surface of the board of the electronic device. Technical studies are performed on this structure.

In the meantime, technical studies are performed on the performance enhancement in small coil components. One of technical trends is replacement of the magnetic material from ferrite to metal magnetic material. The replacement of the magnetic material in the coil component is necessary from the viewpoint of an electric current load. Specifically, the saturation characteristics with respect to the current is changed by the replacement of the magnetic material, and downsizing of the coil component becomes possible under the same current load.

Improvement of productivity is also required with increasing use of the metal magnetic materials in coil components. For example, JP-A-2016-92422 discloses a method of cutting a sheet-shaped molded item, which is made by utilizing some steps of a conventional lamination process, into a component size. This method provides a coil component that is improved in both size reduction and productivity. However, the coil component of JP-A-2016-92422 needs to form outer electrodes on an end face of the coil component, i.e., the cut surface of the coil component. This inhibits narrowing of the pitch (spacing) between the coil components, and therefore inhibits high-density mounting of the coil components.

JP-A-2020-17621 discloses a coil array component that covers an exposed electrode with an insulating layer on an end face of a base body (element body).

Conventionally, therefore, the metal magnetic material is employed to enhance performance and downsizing, and the insulating layer is employed to achieve narrowing of the pitch between the components. Combinations of these conventional techniques are also proposed.

### SUMMARY OF THE INVENTION

However, when the insulating layer is provided, the insulating layer needs sufficient thickness to secure the insulating property. Also, it is necessary to prevent adhesion of the insulating material on the electrode provided on the bottom face of the electronic component. These facts inhibit the downsizing of the electronic component and therefore inhibit high-density mounting of the electronic components.

One object of the present invention is to provide a coil component capable of high-density mounting.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a coil component that includes a magnetic body, made from an insulating material and metal magnetic particles joined by the insulating material. The magnetic body has a first surface and a second surface. The first surface 1s adjacent to the second surface. A surface resistivity of the second surface 1s higher than a surface resistivity of the first surface. The coil component also includes a conductor portion provided inside or on the magnetic body. The coil component also includes an outer electrode provided on the first surface and connected to the conductor portion.

Preferably, the magnetic body further has a third surface, which is opposite to the second surface and is adjacent to the first surface, and a surface resistivity of the third surface is higher than the surface resistivity of the first surface.

Preferably, the magnetic body further has a fourth surface, which is adjacent to the first and second surfaces, and a fifth surface, which is adjacent to the first and second surfaces. A surface resistivity of the fourth surface 1s higher than the surface resistivity of the first surface and a surface resistivity of the fifth surface 1s higher than the surface resistivity of the first surface.

Preferably, the surface resistivity of the third surface 1s different from the surface resistivity of the second surface 10% or less, the surface resistivity of the fourth surface 1s different from the surface resistivity of the second surface 10% or less, and the surface resistivity of the fifth surface 1s different from the surface resistivity of the second surface 10% or less.

Preferably, the magnetic body further has a sixth surface opposite to the first surface, and a surface resistivity of the sixth surface 1s higher than the surface resistivity of the first surface.

Preferably, the surface resistivity of any of the third to sixth surfaces is different from the surface resistivity of the second surface 10% or less.

Preferably, the outer electrode is provided within an outer periphery of the first surface when viewed in a direction perpendicular to the first surface.

Preferably, the outer electrode is spaced from the second surface, the third surface, the fourth surface and the fifth surface.

Preferably, the magnetic body is prepared by a molding process and a subsequent surface processing, and a surface resistivity of a surface of a blank, which is made by the molding process, may be twice or more a surface resistivity of the blank that has undergone the surface processing.

According to another aspect of the present invention, there is provided a circuit board arrangement that includes any of the coil component described above, and a board on which the coil component is mounted.

According to still another aspect of the present invention, there is provided a method of manufacturing a coil component that includes preparing a molded body having six surfaces by molding raw material particles with an insulating binder. The raw material particles are made from a metal magnetic material. The insulating binder binds the raw material particles. The manufacturing method also includes machining at least one surface of the six surfaces of the molded body to remove the raw material particles and the binder from that surface thereby making that surface a machined surface. The manufacturing method also includes applying a plating process to the machined surface to make an outer electrode.

According to the present invention, it is possible to obtain a coil component capable of high-density mounting.

### BRIEF DESCRIPTION OF THE DRAWINGS

FIG. 1 is a perspective view of a coil component according to an embodiment of the present invention.

FIG. 2 is a cross-sectional view of the coil component shown in FIG. 1, taken along the line II-II in FIG. 1.

FIG. 3 is a bottom view of the coil component shown in FIG. 1.

FIG. 4 shows another arrangement of outer electrodes of the coil component.

FIG. 5 shows an example of high-density mounting of the coil components.

FIG. 6 is a flowchart showing an exemplary method of manufacturing a coil component.

FIG. 7 schematically shows a microscopic structure of a surface made upon molding.

FIG. 8 schematically shows a microscopic structure of a machined surface.

### DETAILED DESCRIPTION OF THE INVENTION

Hereinafter, embodiments of the present invention will be described in detail with reference to the accompanying drawings. The following embodiments are not intended to limit the present invention, and not all of the combinations of features described in the embodiments are essential to the configuration of the present invention. Configurations of the respective embodiment may be appropriately modified or changed depending on specifications and various conditions of a device to which the present invention is applied (use conditions, use environment, etc.).

The technical scope of the invention is defined by the claims and is not limited by the following embodiments. For the sake of clarity, the drawings used in the following description may differ from the actual structure in scale and shape. The components shown in one of the drawings may be referred to in the description of other drawings.

### Structure of a Coil Component

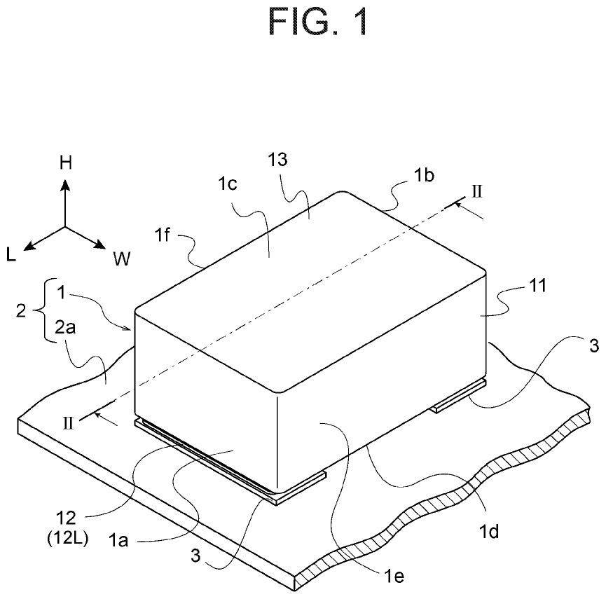

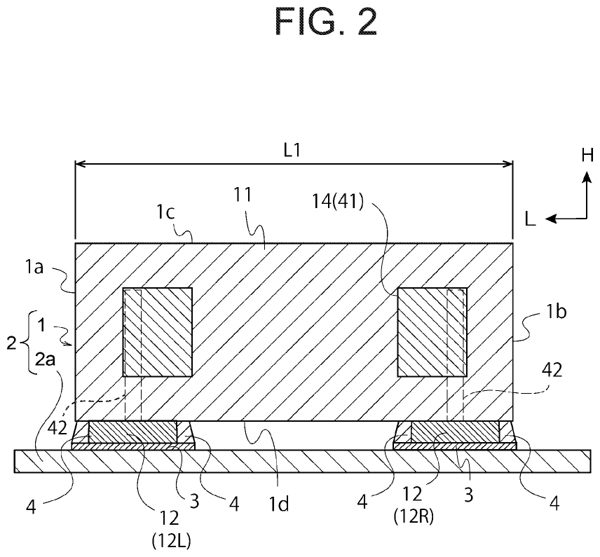

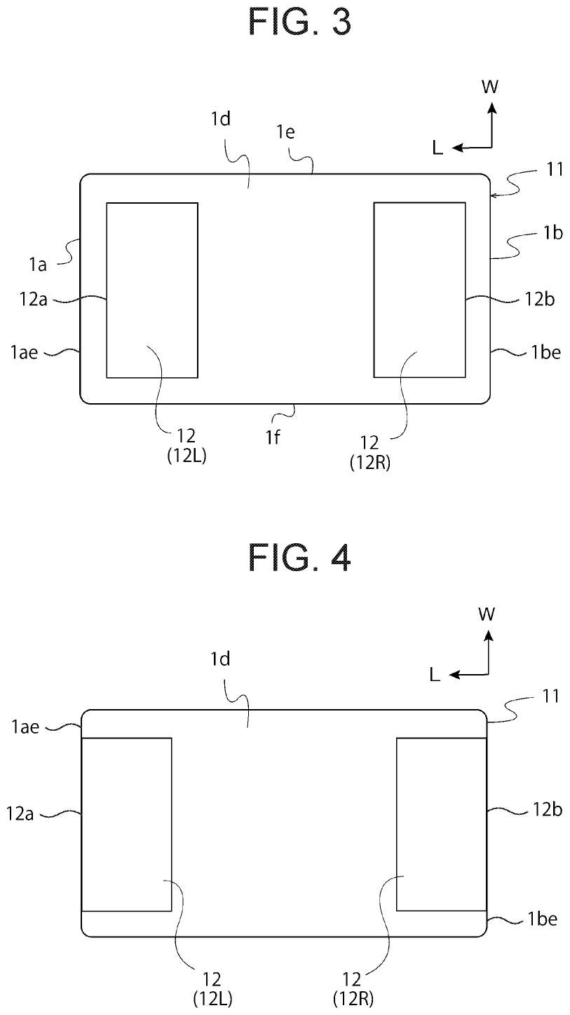

FIGS. 1 to 3 respectively show a coil component 1 according to an embodiment of the present invention. Specifically, FIG. 1 illustrates a perspective view of the coil component 1, FIG. 2 illustrates a cross-sectional view of the coil component 1, taken along the line II-II in FIG. 1, and FIG. 3 illustrates the bottom view of the coil component 1.

The coil component 1 is mounted on a substrate or a board 2a. A combination of the coil component 1 and the board 2a may be referred to as a circuit board arrangement 2. For example, two land portions 3 are provided on the board 2a. The coil component 1 has one magnetic base body (magnetic body) 11 and two outer electrodes 12. The coil component 1 is mounted on the board 2a as the outer electrodes 12 are joined to the land portions 3 by solder 4. The arrow (axis) H indicates the height direction of the coil component 1. The arrow (axis) L indicates the length direction of the coil component 1. The arrow (axis) W indicates the width direction of the coil component 1. The left outer electrode 12 may be referred to as the left outer electrode 12L, and the right outer electrode 12 may be referred to as the right outer electrode 12R. When viewed in the H-axis direction, the area of each of the land portions 3 is equal to or less than 1.6 times the area of the associated outer electrode 12. Preferably, when viewed in the H-axis direction, the area of the land portion 3 is equal to or less than 1.3 times the area of the outer electrode 12.

The circuit board device (circuit board arrangement) 2 of this embodiment includes the coil component 1, and the substrate (board) 2a on which the coil component 1 is mounted. The circuit board arrangement 2 may be used in various electronic devices. Examples of the electronic device having the circuit board arrangement 2 include electrical components of an automobile, a server, and a board computer.

The coil component 1 may be an inductor, a filter, a reactor or other coil components. The coil component 1 may be a coupled inductor, a transformer, a choke coil or other magnetic coupling type coil components. The coil component 1 may be an inductor used in a DC/DC converter.

In this specification, unless otherwise understood by context, the L-axis direction may be referred to as the length direction L of the coil component 1, the W-axis direction may be referred to as the width direction W of the coil component 1, and the H-axis direction may be referred to as the height direction H of the coil component 1.

The coil component 1 has a rectangular parallelepiped shape. Thus, the coil component 1 has end surfaces 1a and 1b at opposite ends in the length direction L, has a top surface 1c and a bottom surface 1d at opposite ends in the height direction H, and has a front surface 1e and a rear surface 1f at opposite ends in the width direction W. The coil component 1 has eight corners and twelve ridges that connect the eight corners. The bottom surface 1d is a mounting surface that will face the substrate 2a when the coil component 1 is mounted on the substrate 2a. The end surface 1a may be referred to as a left surface and the end surface 1b may be referred to as a right surface.

A dimension L1 of the longest side (ridge) of the coil component 1, which decides the external dimension of the coil component 1, is smaller than 5.0 mm, or smaller than 2.5 mm, or even smaller than 2.0 mm. When viewed in the height direction L, the size of each of the outer electrodes 12 may be less than 20% of the coil component 1, or even less than 10% of the coil component 1. Weight per unit volume of the coil component 1 may be greater than 0.6 g/mm³, or greater than 0.65 g/mm³, or even greater than 0.70 g/mm³. Weight per unit area of the outer electrode 12 of the coil component 1 may be greater than 0.025 g/mm², or greater than 0.027 g/cm², and even greater than 0.029 g/cm².

Each of the six surfaces 1a-1f of the coil component 1 may be a curved surface or a flat surface. The eight corners and the twelve ridges of the coil component 1 may be rounded or chamfered.

In this specification, even if a part of the outer surface of the coil component 1 is curved, the corner is rounded and the ridge is rounded, the coil component 1 may be referred to as a “rectangular parallelepiped shape”. That is, in this specification, the “rectangular parallelepiped” or “rectangular parallelepiped shape” does not mean a “rectangular parallelepiped” in a mathematically strict sense.

The coil component 1 of the first embodiment has the magnetic base body (magnetic portion) 11 and the two outer electrodes 12, and has the coil conductor (conductor portion) 14 in the magnetic base body 11.

The magnetic base body 11 has six surfaces. For example, the magnetic base body 11 has a rectangular parallelepiped shape. The end faces (side surfaces) 1a, 1b, the upper surface 1c, the bottom surface 1d, the front surface 1e and the rear surface 1f of the magnetic base body 11 are, in effect, the end faces 1a, 1b, the upper surface 1c, the bottom surface 1d, the front surface 1e and the rear surface 1f of the coil component 1. As one example, the bottom surface 1d may be referred to as a first surface, the left surface 1a may be referred to as a second surface, the right surface 1b may be referred to as a third surface, the front surface 1e may be referred to as a fourth surface, the rear surface 1f may be referred to as a fifth surface, and the upper surface 1c may be referred to as a sixth surface. The first surface is adjacent to the second surface, the third surface, the fourth surface and the fifth surface. The first surface 1s opposite to the sixth surface. One surface being adjacent to another surface means that the two surfaces are orthogonal to each other in this embodiment. One surface being opposite to another surface means that the two surfaces face in the opposite directions.

The magnetic base body 11 of this embodiment is a magnetic body that is formed from a metallic magnetic material (particles) and a coupling material (binder). The coupling material is used to couple (bind) the metal magnetic materials with each other. Coupling is a first role of the coupling material. The coupling material is highly insulating because a second role of the coupling material is to prevent electrical conduction. The coupling material is selected such that the surface resistivity of the magnetic base body 11 becomes equal to or more than 10⁵ Ω/sq. If a main component of the metal magnetic material is Fe, the metal magnetic material has a low resistance (resistivity). Thus, it is desirable to adjust the components and blending ratio of the binding material in accordance with the metal magnetic material. Preferably, the coupling material has resistivity (specific resistance) of 10⁸ Ωcm or more. For the purpose of increasing the insulating property, the coupling material may contain a resin. Alternatively, the coupling material may contain glass or a metal oxide. The surface resistance of the base body 11 is measured by, for example, the Ultra High Resistance Meter 5451, manufactured by ADC Corporation, Tokyo, Japan while a dielectric breakdown voltage is measured by, for example, the withstand voltage meter HIPOT 19055-C, manufactured by Chroma Japan Corporation, Yokohama, Japan. Two parallel probes contact the surface of the base body 11. The two probes are spaced from each other with a distance of 10 mm. The two probes extend perpendicular to the surface of the base body 11. 20V, 40V, 60V, 80V and 100V (all DC voltages) are sequentially applied across the two probes, and the resistance and breakdown voltage are measured at each voltage. Each voltage is applied one second (1 sec). Because the surface of the base body 11 is covered with the insulating material, the two probes directly contact the surface of the base body 11.

The resistivity inside the magnetic base body 11 is very high. Also, the resistivity on the surface of the base body 11 is very high. The coupling material exists on the surface of the base body 11. The metal magnetic material is constituted by metal magnetic particles that contain one or more of Fe, Ni and Co. The metal magnetic material may also contain, in addition to the metal magnetic particles, ceramic magnetic particles (including one or more of Mg, Mn and Ni) and/or non-magnetic particles (e.g., silica). The metal magnetic particles may contain at least one of Si, Cr, Al, B and P in addition to Fe, Ni and/or Co. Also, a combination of plural kinds of metal magnetic particles may be used as the metal magnetic particles of the metal magnetic material of the base body 11.

The size of each of the particles contained in the metal magnetic material is between 1 μm and 60 μm. If the metal magnetic material includes additional materials (e.g., fine metal particles, metal oxides, and ceramic materials) in addition to the metal magnetic particles, the particle size of these additional materials is between 0.01 μm and 1 μm in average, i.e., the average particle size of the additional materials is smaller than that of the metal magnetic particles. When the metal magnetic material includes the additional materials in addition to the metal magnetic particles, it is possible to reduce voids, or supplement (enhance) the mechanical strength, rather than increasing the magnetic function. A packing ratio of the metal magnetic material in the magnetic base body 11 is between 80 vol % and 88 vol %, and the balance (12 vol % to 20 vol %) is other than the metal magnetic material, which includes an insulator (or insulators) and voids.

The conductor 14 is made of a metallic material (or metallic materials) having excellent conductivity. The metallic material(s) of the coil conductor 14 may be, for example, one or more of Cu, Al, Ni and Ag, or may be an alloy containing any of these metals. The coil conductor 14 may be a conductive and winding wire of a metal that has an insulator provided on the surface of the wire, or may be formed on a surface of a substrate or sheet by plating, printing or the like.

The coil conductor 14 of this embodiment has a winding part (winding wire) 41. The winding part 41 has one or more turns of wire. For example, the winding part 41 has turns between 1.5 turns and 10.5 turns. If the dimension in the length direction L of the coil component 1 is between 1.0 mm and 2.5 mm, the number of turns of the winding wire 41 is, for example, between 1.5 turns and 6.5 turns. The shape of the winding wire 41 may be planar or spiral. The winding wire 41 may be a combination of, for example, two winding wires (e.g., an upper winding wire and a lower winding wire). The upper winding wire may be separated from the lower winding wire and face the lower winding wire. Alternatively, the coil conductor 14 may not have the winding wire 41 and may have a linear shape or a stepped shape.

The conductor 14 may be divided into a plurality of individual elements. These elements are insulated from each other, and each of the elements functions as a coil. If the conductor 14 of the coil component 1 is divided into a plurality of parallel elements, the coil component 1 may be referred to as an array type (i.e., the elements are arranged in parallel). Another example of the coil component 1 whose conductor 14 is divided into a plurality of elements may have a configuration in which the individual elements are magnetically coupled to each other. Specific examples of the coil component 1 whose conductor 14 is divided into a plurality of elements include a transformer, a common mode choke coil, a coupled inductor and the like.

The coil conductor 14 has two lead portions 42 for electric connection with the outside. The lead portions 42 are provided at both ends of the winding part 41 such that the lead portions 42 connect the respective outer electrodes 12 to the coil conductor 14. The coil conductor 14 may be fabricated by a wire winding process, a thin film formation process or a multilayer formation process. Also, any other suitable process may be used to fabricate the coil conductor 14.

In FIG. 2, the winding wire 41 is generally parallel to the bottom surface 1d and the upper surface 1c of the magnetic base body 11. Thus, the coil conductor 14 has a so-called horizontally winding wire 41 (a horizontally aligned winding structure with a vertical winding axis). Alternatively, the winding wire 41 may be generally parallel to the left surface 1a and the right surface 1b of the magnetic base body 11. In this configuration, the coil conductor 14 has a so-called vertically winding wire 41.

The coil component 1 has a pair of outer electrodes 12 provided on the bottom surface 1d. The bottom surface 1d corresponds to the first surface of the magnetic base body 11. In this specification, the expression “something provided on a surface” means that the “something” is visible when the surface 1s looked at. For example, even if the “something” is partly buried in the surface, the “something” is provided on the surface. Also, even if the “something” protrudes from the surface, the “something” is provided on the surface. If the surface of the magnetic base body 11 has a protrusion and the outer electrode 12 covers the protrusion, the outer electrode 12 is “provided on the surface.”

Each of the outer electrodes 12 is formed from one or more common metal materials and has a metal layer made of one or more of Ag, Cu, Ti, Ni and Sn. The thickness of the metal layer may be, for example, between 0.01 μm and 5 μm. It should be noted that the outer electrode 12 may be made from a plurality of metal layers and the combined thickness may be between 5 μm and 10 μm. Alternatively, the outer electrode 12 may be made from a metal layer (or metal layers) and a resin layer (or resin layers). The resin layer contains a resin. The combined thickness of the metal layer(s) and the resin layer(s) may be between 10 μm and 20 μm.

When viewed in the height direction H, each of the outer electrodes 12 has an area that is decided on the basis of the external dimension of the coil component 1 or the dimension of the bottom surface 1d such that the area of the outer electrode 12 has a size sufficient for mounting on the board 2a. For example, the ratio of the total area of the two outer electrodes 12 to the area of the bottom surface 1d, which is determined from the external dimension of the coil component 1, is 50% or less. In this embodiment, since a pair of outer electrodes 12 is provided, the ratio of the area of the single outer electrode 12 is 25% or less of the area of the bottom surface 1d.

The outer electrodes 12 are provided within the outer periphery of the bottom surface 1d, i.e., the outer electrodes 12 do not extend onto the end faces 1a, 1b, the front surface 1e, and the rear surface 1f. Therefore, enlargement of the external dimensions of the coil component 1 due to the presence of the outer electrodes 12 does not occur, and it is possible to maximize the physical size of the magnetic base body 11. The outer electrodes 12 may extend to the boarders to the left surface 1a, the right surface 1b, the front surface 1e and the rear surface 1f without increasing the external dimensions of the coil component 1. Thus, it is possible to maximize the size of the outer electrodes 12 on the bottom surface 1d.

In this embodiment, as shown in FIGS. 2 and 3, the outer electrodes 12 do not extend to the outer periphery of the bottom surface 1d. That is, the outer electrodes 12 do not reach the left surface 1a, the right surface 1b, the front surface 1e and the rear surface 1f. The arrangement of the outer electrodes 12 shown in FIGS. 2 and 3 allows the solder 4 to stay within the outer periphery of the bottom surface 1d. This contributes to high-density mounting because the area required for mounting the coil component 1 on the board 2a is small. In FIG. 3, the edge of the left surface 1a is designated at 1ae, and the edge of the right surface 1b is designated at 1be. Also, the left edge of the left outer electrode 12L is designated at 12a, and the right edge of the right outer electrode 12R is designated at 12b.

The arrangement of the outer electrodes 12 is not limited to the arrangement shown in FIG. 3. For example, the outer electrodes 12 may be provided in an arrangement shown in FIG. 4. In FIG. 4, the left outer electrode 12L reaches the left surface 1a, and the right outer electrode 12R reaches the right surface 1b. Specifically, the left edge 12a of the left outer electrode 12L reaches the edge 1ae of the left surface 1a, and the right edge 12b of the right outer electrode 12R reaches the edge 1be of the right surface 1b. Even when the outer electrodes 12 are provided at the positions shown in FIG. 4, the expansion of the external dimensions of the coil component 1 due to the presence of the outer electrodes 12 does not occur, and the area required for mounting the coil component 1 on the board 2a is small. This contributes to high-density mounting of the coil component 1. It should also be noted that the left outer electrode 12L may extend from the bottom surface 1d to a certain area of the left surface 1a, and the right outer electrode 12R may extend from the bottom surface 1d to a certain area of the right surface 1b. If the outer electrode 12 extends to the surface 1a/1b from the bottom surface 1d, such outer electrode 12 is referred to as a double-surface electrode. If the outer electrode 12 does not extend to the surface 1a/1b, the outer electrode 12 is referred to a single-surface electrode.

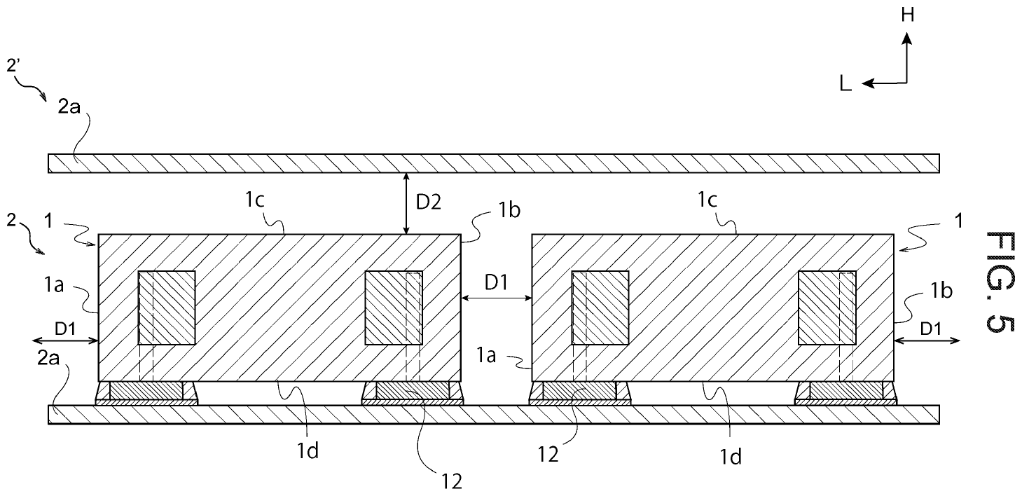

FIG. 5 illustrates an example of high-density mounting of the coil components 1. FIG. 5 shows two coil components 1 that are arranged in the length direction L with a pitch D1.

A surface resistivity of the magnetic base body 11 is higher in the end faces 1a, 1b than in the bottom surface 1d. Each of the end surfaces 1a and 1b is a surface adjacent to the bottom surface 1d when viewed in the length direction L. The two outer electrodes 12 are spaced from each other in the length direction L. In the length direction L as compared to the other directions (i.e., the width direction W and the height direction H), the distance between the outer electrode 12 of the coil component 1 and a neighboring electronic component (e.g., another coil component 1) tends to be close when the coil component 1 and the neighboring electronic component are mounted on the board 2a. However, since the surface resistivity of the end face 1a, 1b adjacent to the bottom surface 1d in the length direction L is large, it is possible to reduce the interval (pitch) D1 between the coil component 1 and the other electronic component (i.e., narrowing of the pitch can be achieved). Further, the difference in the surface resistivity between the end faces 1a and 1b is 10% or less. Therefore, adjustment of the component spacing D1 between the coil component 1 and the other electronic component in the length direction L is not required.

The surface resistivity of the magnetic base body 11 is higher in the front surface 1e and the rear surface 1f than in the bottom surface 1d. Therefore, it is possible to narrow the pitch between the components in the width direction W. Further, the surface resistivity difference between the end face 1b and the end face 1a is 10% or less, the surface resistivity difference between the front surface 1e and the end face 1a is 10% or less, and the surface resistivity difference between the rear surface 1f and the end face 1a is 10% or less. Therefore, narrowing the pitch between the coil component 1 and another component is achieved in any horizontal direction (i.e., the width direction W and the length direction L), and the adjustment of the component spacing also becomes unnecessary in any horizontal direction.

The surface resistivity of the magnetic base body 11 is higher in the top surface 1c than in the bottom surface 1d. Therefore, if another board 2a (or another circuit board arrangement 2′) is disposed above the circuit board arrangement 2 (i.e., if a plurality of circuit board arrangements 2 and 2′ is disposed in the height direction H), it is possible to reduce the interval D2 between the top surface 1c of the lower circuit board arrangement 2 and the board 2a of the upper circuit board arrangement 2′. Further, the surface resistivity difference between the end face 1b and the end face 1a, between the front surface 1e and the end face 1a, between the rear surface 1f and the end face 1a and between the top surface 1c and the end face 1a is 10% or less. Therefore, narrowing the pitch between the coil component 1 and another component is achieved in any direction, and the adjustment of the component spacing also becomes unnecessary in the width direction W and the length direction L as well as in the height direction H.

Since the magnetic base body 11 or the coil component 1 is insulating without having an insulating coat, the downsizing of the coil component 1 can be achieved and high-density mounting of the coil components 1 is realized.

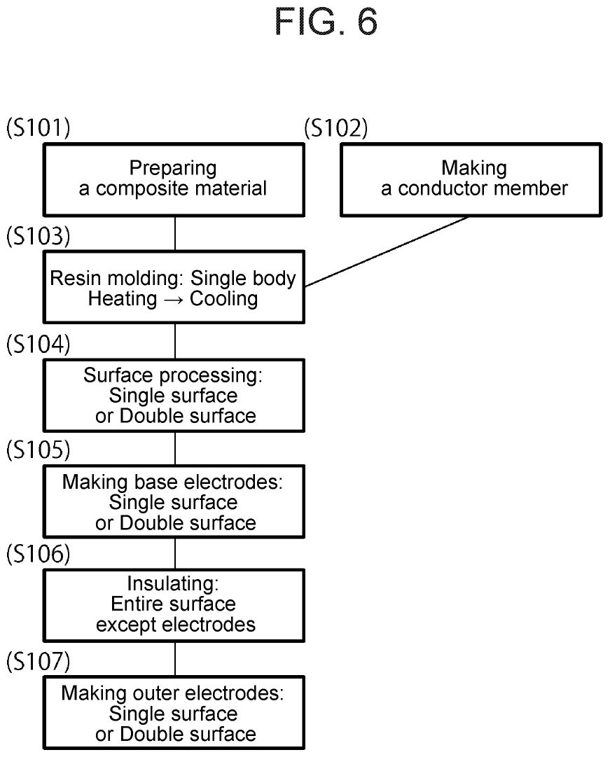

Next, a method of manufacturing the coil component 1 will be described with reference to FIG. 6.

FIG. 6 is a flowchart showing an exemplary method of manufacturing the coil component 1.

Step S101 of the manufacturing method prepares a composite material. In Step S101, raw material grains, which become the metallic magnetic material of the coil component 1, and a binder, which becomes the insulating material of the coil component 1, are mixed to make the composite material. In Step S102, a conductor member, which becomes the coil conductor 14 of the coil component 1, is prepared. The conductor member may be made from, for example, wires (conductors) or may be made by printing or plating of a conductive material. The process of making the conductor member may include, for example, a wire winding process, a laminating process, and/or a thin film making process.

Step S103 is a molding process. In the molding process, the conductor member is placed in a mold, and the hot composite material is loaded into the mold. Then, a compression force is applied to the mold, and the mold is cooled to complete the molding process. The molding process therefore provides a blank (molded body), which integrates with the conductor member. A resin component may be present on a part of the surface of the mold in the molding process. Preferably, this resin component does not soften at a heating temperature in the molding process. The resin component is, for example, a thermosetting resin. The blank (molded body) obtained by Step S103 becomes the magnetic base body 11 in a single coil component 1. The blank is, for example, a six-sided body.

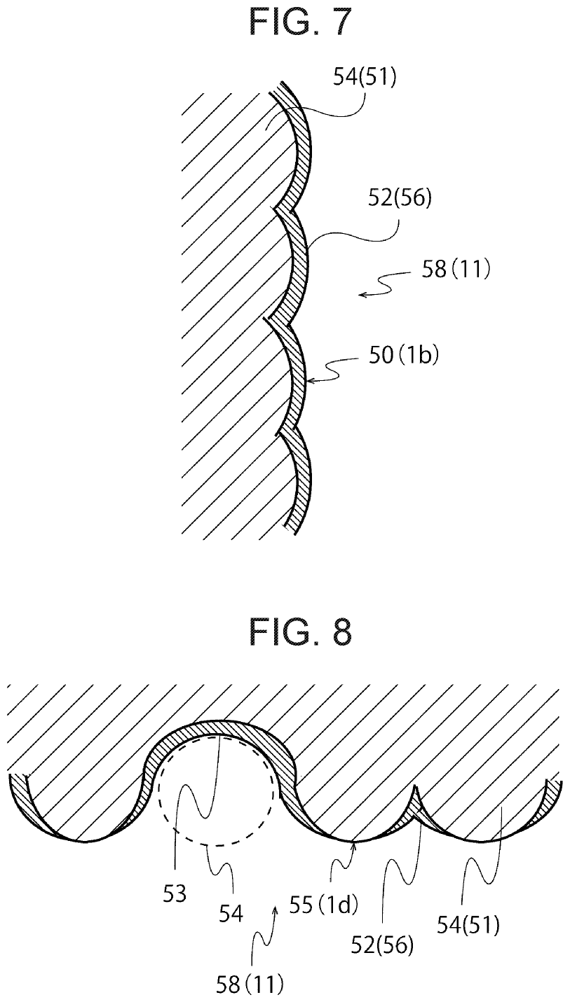

FIG. 7 schematically shows a microscopic structure of the surface 50 of the blank prepared by Step S103.

FIG. 7 depicts the surface 50 corresponding to the end face 1b as an example.

When the composite material is loaded and compressed in the mold, it is compressed at a pressure lower than, for example, 10 MPa. As a result, the raw material particles 54 are not deformed very much, i.e., the change in the aspect ratio of the metal magnetic particles 51 obtained from the raw material particles 54 is smaller than 10%.

At the time of loading the composite material, the composite material is heated to a temperature higher than the softening temperature of the binder 52 so that the binder 52 is easy to move. After the compression, the composite material and the binder 52 are cooled to a temperature lower than the softening temperature of the binder 52, Thus, the binder 52 is no longer movable, and the blank 58 is obtained. That is, the molding process of Step S103 less relies on pressure than a conventional method. Rather, the molding process of this embodiment relies on a combination of heating and cooling to provide the blank 58, with the binder 52 being present on the surface of the raw material particles 54. Consequently, the binder 52 is uniformly present on the entire outer surface of the blank 58, and the insulating material 56 formed from the binder 52 is also present in the same manner (present uniformly on the entire surface 50). Therefore, the area where the surface of the raw material particles 54 is exposed on the surface of the blank 58 is small or none, i.e., it is possible to reduce the number of the exposed raw material particles 54 or make that number zero. The surface resistivity of the surface 50 is high, and the difference in the surface resistivity between one position on the surface 50 and any other position on the surface 50 is small. The surface resistivity of the surface 50 may be decided by the size and packing factor of the raw material grains 54, and the specific resistance of the binder 52. In this embodiment, the surface resistivity of the surface 50 is 10⁸ Ω/sq. or less. In this manner, the blank 58 in which the surface of the raw material particles 54 is covered with the binder 52 is obtained by the molding process, and the magnetic base body 11 obtained from the blank 58 has a configuration in which the surface of the metal magnetic particles 51 are covered with the insulating material 56. It should be noted that although FIG. 7 illustrates the molded surface 50 of the blank 58, the description of FIG. 7 also applies to the surface of the magnetic base body 11 obtained from the blank 58 and the surface of the metal magnetic particles 51 obtained from the raw material particles 54.

Referring back to FIG. 6, the description of the manufacturing method will continue.

Step S104 is a processing (machining) step. Specifically, particular areas of the outer surface 50 of the blank (molded article) 58, on which the outer electrodes 12 are provided, undergo the surface processing to expose the lead portions 42 of the coil conductor 14. In this surface processing, to the extent that enables the formation of the outer electrodes 12, a process of lowering the resistance (resistivity) is applied to the above-mentioned particular areas of the outer surface 50 such that the resistance (resistivity) of the particular areas of the outer surface 50 becomes lower than the remaining area of the surface 50. If the right outer electrode 12R is formed on the bottom surface 1d and extends onto a certain area of the right surface 1b, for example, the surface processing is applied to the bottom surface 1d and the “certain area” of the right surface 1b. It should be noted that in this configuration, the surface processing to the right surface 1b is limited to the “certain area” and most of the right surface 1b remains as the surface 50.

In Step S104, the surface processing may be applied in a manner that removes the binder 52 from the surface of the blank 58, or in a manner that removes the raw material particles 54.

The surface processing to remove the binder 52 may be carried out by applying a damage to the binder 52 using a laser or sandblasting such that the binder 52 is firstly removed and then the raw material particles 54 are removed. The surface processing to remove the raw material particles 54 may be carried out by applying a load to the raw material particles 54 using polishing such that the raw material particles 54 are firstly removed and then the binder 52 is removed.

FIG. 8 schematically shows a microscopic structure of the machined surface (i.e., the surface after the surface processing) 55.

In FIG. 8, the machined surface 55 corresponding to the bottom surface 1d is shown as an example. Although the surface of the raw material particles 54 in the machined surface 55 is covered with the binder 52, the binder 52 is reduced by the surface processing, and therefore the surface resistivity of the machined surface 55 is lower than that of the surface 50.

It should be noted that although FIG. 8 illustrates the machined surface 55 of the blank 58, the description of FIG. 8 also applies to the surface of the magnetic base body 11 obtained from the blank 58 and the surface of the metal magnetic particles 51 obtained from the raw material particles 54.

If the surface processing to remove the binder 52 is used, the binder 52 is damaged and therefore the surface resistivity of the machined surface 55 drops. Thus, the surface resistivity of the machined surface 55 becomes smaller than the surface resistivity of the molded surface 50. If the surface processing to remove the raw material particles 54 is used, the binder 52 is partly lost from the machined surface 55 and/or the metal surface of the raw material particles 54 is exposed. As a result, the surface resistivity of the machined surface 55 drops, i.e., the surface resistivity of the machined surface 55 becomes smaller than the surface resistivity of the molded surface 50. The drop rate of the surface resistivity is greater in the surface processing of removing the binder 52 than in the surface processing of removing the raw material particles 54.

In the machined surface 55, some of the raw material particles 54 are removed and recesses 53 are formed. Thus, the surface roughness of the machined surface 55 is greater than the surface roughness of the molded surface 50. On the other hand, since the molded surface 50 has not yet subjected to the surface processing, the surface roughness of the molded surface 50 is smaller than the surface roughness of the machined surface 55. Therefore, use of the molded surface 50 is advantageous in handling the blank 58 (e.g., when conveying the blank 58 using the molded surface 50), and falling off of the raw material particles 54 from the molded surface 50 is suppressed. This is the same in the magnetic base body 11, i.e., it is easy to maintain the state (condition) of the molded surface 50.

After the blank (molded body) 58 has undergone the surface processing of Step S104, Step S105 is carried out. Specifically, sputtering or vapor deposition is applied to the machined surface 55 of the blank 58 in Step S105 such that two base electrodes (underlying electrodes) made of a metallic film are formed. The two base electrodes are portions of the two outer electrodes 12, respectively. The base electrode is formed in a forming area of each of the outer electrodes 12. For example, the base electrodes are formed only on the bottom surface 1d if the two outer electrodes 12 are formed on the single surface (bottom surface 1d) of the coil component 1. If the left outer electrode 12L extends to a neighboring area on the left surface 1a from the bottom surface 1d, the base electrode of the left outer electrode 12L also extends to that area from the bottom surface 1d. If the right outer electrode 12R extends to a neighboring area on the right surface 1b from the bottom surface 1d, the base electrode of the right outer electrode 12R also extends to that area on the right surface 1b from the bottom surface 1d.

In Step S106 of FIG. 6, the insulating treatment is performed to increase the insulating property of the surface of the molded body 58. The insulating treatment is, for example, acid treatment or substitution treatment. In the acid treatment, the raw material particles 54 present on the surface of the molded body 58 are selectively removed. In the substitution treatment, for example, phosphoric acid treatment is carried out such that the metal surface of the raw material particles 54 present on the surface of the molded body 58 is replaced with an insulator by substitution. The insulation treatment, which may be the substitution process or the acid treatment, does not increase the outer dimensions of the magnetic base body 11 obtained from the molded body 58 as compared with the outer dimensions of the molded body 58 before the insulation treatment. Further, the outer dimensions of the molded body 58 after the insulation treatment is not greater than the outer dimensions of the molded body 58 before the insulation treatment. In particular, since the insulating treatment is applied to the raw material particles 54 exposed to the surface 50 of the molded body 58, the insulating treatment does not cause a change in the outer dimensions of the molded body 58. Therefore, it can be said that the insulating treatment of this embodiment can reduce the outer dimensions of the molded body 58 as compared with a configuration in which the insulating material is provided on the entire molded surface 50.

As described above, the surface resistivity of the molded surface 50 is greater than the surface resistivity of the machined surface 55. If the insulating treatment of Step S106 is not performed to the machined surface 55, the surface resistivity of the machined surface 55 is 10⁵ Ω/sq. or more whereas if the insulating treatment of Step S106 is performed to the machined surface 55, the surface resistivity of the machined surface 55 becomes 10⁶ Ω/sq. or more.

If the insulating treatment is not performed, the surface resistivity of the molded surface 50 is 10 times or more the surface resistivity of the machined surface 55. If the insulating treatment of Step S106 is performed, the surface resistivity of the molded surface 50 becomes twice or more the surface resistivity of the machined surface 55. Since the binder 52 more exists on the surface of the molded surface 50 than on the surface of the machined surface 55, the effect of the insulating treatment on the molded surface 50 is different from the effect of the insulating treatment on the machined surface 55. Specifically, the increase of the surface resistivity of the molded surface 50 is smaller than the increase of the surface resistivity of the machined surface 55.

In Step S107, an intermediate layer, which is made of a conductive resin material, is provided on the outer surface of each of the base electrodes by printing or coating. Then, a metallic layer is provided on the outer surface of each of the intermediate layers by electrolytic plating to form each of the outer electrodes 12. The outer boundary of the outer electrode 12 is within the outer boundary of the base electrode when viewed in the height direction L. For example, if the base electrodes are only formed on the bottom surface 1d, the outer electrodes 12 are formed only on the bottom surface 1d. If the base electrodes are formed on the bottom surface 1d and also on certain areas of the end faces 1a and 1b, the left outer electrode 12L is formed from the bottom surface 1d and the left face 1a and the right outer electrode 12R is formed on the bottom surface 1d and the right face 1b.

The formation of the outer electrodes 12 completes the manufacturing of the coil component 1.

Since the manufacturing method shown in FIG. 6 is employed in this embodiment and the molding process of Step S103 is carried out in the manufacturing method, the surface resistivity of the molded surface 50 of the blank 58 is large or the difference in surface resistivity between one position of the molded surfaces 50 of the blank 58 and any other position of the molded surface 50 of the blank 58 is small. Therefore, the surface processing of Step S104 can easily provide the processed surface 55 having a smaller surface resistivity than the molded surface 50. Thus, it is easy for the magnetic base body 11 of the coil component 1 to have the machined surface 55 whose surface resistivity is smaller than the molded surface 50.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A coil component comprising:
a magnetic body, made from an insulating material and metal magnetic particles joined by the insulating material, the magnetic body having a first surface and a second surface, the first surface being adjacent to the second surface, a surface resistivity of the second surface being higher than a surface resistivity of the first surface;
a conductor portion provided inside or on the magnetic body; and
an outer electrode provided on the first surface and connected to the conductor portion.

2. The coil component according to claim 1, wherein the magnetic body further has a third surface, which is opposite to the second surface and is adjacent to the first surface, and a surface resistivity of the third surface 1s higher than the surface resistivity of the first surface.

3. The coil component according to claim 2, wherein the magnetic body further has a fourth surface, which is adjacent to the first and second surfaces, and a fifth surface, which is adjacent to the first and second surfaces and is opposite to the fourth surface, a surface resistivity of the fourth surface 1s higher than the surface resistivity of the first surface and a surface resistivity of the fifth surface 1s higher than the surface resistivity of the first surface.

4. The coil component according to claim 3, wherein the surface resistivity of the third surface 1s different from the surface resistivity of the second surface 10% or less, the surface resistivity of the fourth surface 1s different from the surface resistivity of the second surface 10% or less, and the surface resistivity of the fifth surface 1s different from the surface resistivity of the second surface 10% or less.

5. The coil component according to claim 1, wherein the magnetic body further has a sixth surface opposite to the first surface, and a surface resistivity of the sixth surface 1s higher than the surface resistivity of the first surface.

6. The coil component according to claim 5, wherein the surface resistivity of any of the third to sixth surfaces is different from the surface resistivity of the second surface 10% or less.

7. The coil component according to claim 1, wherein the outer electrode is provided within an outer periphery of the first surface when viewed in a direction perpendicular to the first surface.

8. The coil component according to claim 3, wherein the outer electrode is spaced from the second surface, the third surface, the fourth surface and the fifth surface.

9. The coil component according to claim 1, wherein the magnetic body is prepared by a molding process and a subsequent surface processing, and a surface resistivity of a surface of a blank, which is made by the molding process, is twice or more a surface resistivity of the blank that has undergone the surface processing.
